(19) United States
(12) Patent Application Publication
(10) Pub. No.: US 2020/0086934 A1
(43) Pub. Date: Mar. 19, 2020

(54) UNDERCARRIAGE WITH CARRIER PLATE FOR COMPENSATING FOR TRACK LINK RAIL SCALLOPED SURFACE

(71) Applicant: Caterpillar Inc., Deerfield, IL (US)

(72) Inventor: Kevin L. Steiner, Tremont, IL (US)

(73) Assignee: Caterpillar Inc., Deerfield, IL (US)

(21) Appl. No.: 16/130,252

(22) Filed: Sep. 13, 2018

(51) Int. Cl. B62D 55/20; B62D 55/15; B62D 55/215

(52) U.S. Cl. CPC B62D 55/202; B62D 55/26; B62D 55/215; B62D 55/15

(57) ABSTRACT

An undercarriage configured to support a track chain and to be attached to a machine with an endless track drive includes a first carrier plate attached to the undercarriage, the first carrier plate including a material having a hardness of at least 45 Rockwell Scale C or greater.

### TECHNICAL FIELD

The present disclosure relates to a method and apparatus for providing an endless undercarriage drive employed by earth moving, construction and mining equipment and the like with a carrier plate that contacts the track links of a track chain assembly of the undercarriage drive. Specifically, the present disclosure relates to a method and apparatus for compensating for track links having rails that develop scalloped surfaces.

### BACKGROUND

Earth moving, construction and mining equipment and the like are often used in rough, off-road terrain. These machines often employ an endless drive with track shoes that is better able to propel the machines in such environments over obstacles and uneven terrain, etc. The track chains, which include shoes, are held together by a series of interconnected track links, pins and bushings that are supported on the drive sprocket, idler and support rollers of the machine. As can be imagined, machines using a track chain may experience various problems as the machine moves.

For example, the track chains that are routed about the drive sprocket, idler and support rollers have rail surfaces that contact the drive sprocket, idler and support rollers as the track chain moves. Over time, the top rail surfaces of the track links may develop a scalloped surface. This may reduce riding comfort or lead to other problems with the functioning of the undercarriage.

Various solutions have been previously used to prevent the development of the scalloped surface on the rails of the track links. They include thickening, crowing, or otherwise modifying the rail geometry of the track link or adjusting the hardening of the rail portion of the track link, etc. However, once the scalloped surface develops, there are no known solutions that may thereafter significantly prolong the life of the track chain.

Accordingly, it would be beneficial if an apparatus and method were developed that could compensate for the development of track link rail surfaces that are scalloped.

### SUMMARY

An undercarriage configured to support a track chain and to be attached to a machine with an endless track drive according to an embodiment of the present disclosure comprises a plurality of bottom support rollers rotatably attached to the undercarriage including a front bottom support roller defining a front bottom support roller rotational axis and a rear bottom support roller defining a rear bottom support roller rotational axis, a front wheel rotatably attached to the undercarriage, defining a front wheel rotational axis; a rear wheel rotatably attached to the undercarriage, defining a rear wheel rotational axis; a track chain including sets of links, each set of links being joined to each other in a rotatable manner, at least one of the links defining a link pitch distance equivalent to the overall length of the at least one link; and a first carrier plate attached to the undercarriage, the first carrier plate including a material having a hardness of at least 45 Rockwell Scale C or greater.

An undercarriage configured to support a track chain and to be attached to a machine with an endless track drive according to another embodiment of the present disclosure comprises a plurality of bottom support rollers rotatably attached to the undercarriage including a front bottom support roller defining a front bottom support roller rotational axis and a rear bottom support roller defining a rear bottom support roller rotational axis; a front wheel rotatably attached to the undercarriage, defining a front wheel rotational axis; a rear wheel rotatably attached to the undercarriage, defining a rear wheel rotational axis; a track chain including sets of links, each set of links being joined to each in a rotatable manner, at least one of the links defining a link pitch distance equivalent to the overall length of the at least one link. The undercarriage defines a track chain traveling direction, the first carrier plate defines a first carrier plate width in a direction perpendicular to the track chain traveling direction, and at least one of the links defines a rail width in a direction perpendicular to the track chain traveling direction, and the ratio of the rail width to the first carrier plate width ranges from 0.5 to 4.0.

An undercarriage configured to support a track chain and to be attached to a machine with an endless track drive according to yet another embodiment of the present disclosure comprises a plurality of bottom support rollers rotatably attached to the undercarriage including a front bottom support roller defining a front bottom support roller rotational axis and a rear bottom support roller defining a rear bottom support roller rotational axis; a front wheel rotatably attached to the undercarriage, defining a front wheel rotational axis; a rear wheel rotatably attached to the undercarriage, defining a rear wheel rotational axis; a track chain including sets of links, each set of links being joined to each other in a rotatable manner, at least one of the links defining a link pitch distance equivalent to the overall length of the at least one link. The undercarriage defines a track chain traveling direction, the first carrier plate defines a first carrier plate width in a direction perpendicular to the track chain traveling direction, and at least one of the links defines a rail width in a direction perpendicular to the track chain traveling direction, and the ratio of the first carrier plate width to the rail width ranges from 2.0 to 6.0.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 is a side-view of a machine that may use various configurations of an undercarriage supporting the track chain according to various embodiments of the present disclosure.

FIG. 2 is a perspective view of a carrier plate according to various embodiments of the present disclosure.

FIG. 3 is a perspective view of a track link with a rail surface that may be used in various embodiments of the present disclosure.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or by a prime for example, 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters and primes will often not be included herein but may be shown in the drawings to indicate duplications of features, having similar or identical function or geometry, discussed within this written specification.

Various embodiments of an apparatus and a method for providing an undercarriage that is configured to support a track chain and to be attached to a machine with and endless track drive according to the present application will now be described. In various embodiments, a carrier plate that may remove or otherwise compensate for the development of a scalloped surface on a track link rail may be provided.

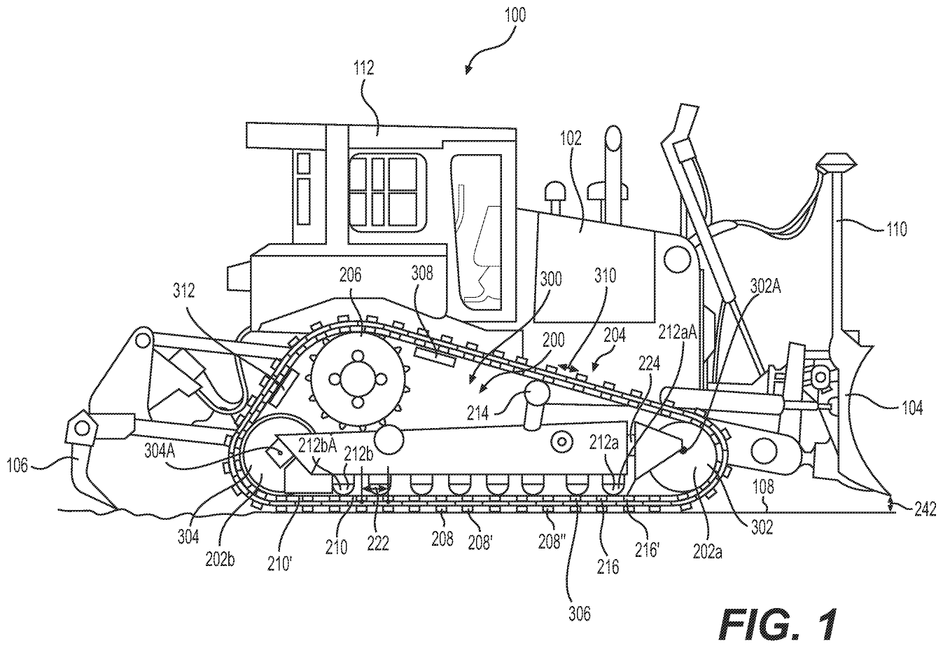

FIG. 1 illustrates an exemplary machine 100 having multiple systems and components that cooperate to accomplish a task. Machine 100 may embody a mobile machine that performs some type of operation associated with an industry such as mining, construction, farming, transportation, or any other industry known in the art. For example, machine 100 may be an earth moving machine such as an excavator, a dozer (as shown in FIG. 1), a loader, a backhoe, a motor grader, or any other earth moving machine. Machine 100 may include a power source 102 and an undercarriage 200, which may be driven by power source 102 and supported by one or more spaced-apart idler wheels 202 (front idler wheel is denoted by 202a while the rear idler wheel is denoted by 202b).

Power source 102 may drive the track chain 204 of the undercarriage 200 of machine 100 at a range of output speeds and torques. Power source 102 may be an engine such as, for example, a diesel engine, a gasoline engine, a gaseous fuel-powered engine, or any other suitable engine. Power source 102 may also be a non-combustion source of power such as, for example, a fuel cell, a power storage device, or any other source of power known or that will be devised in the art.

The undercarriage 200 may include two separate continuous track chains 204, one on either side of machine 100 (only one of which is shown in FIG. 1). Each track chain may be driven by power source 102 via one or more drive sprockets 206. In addition, each track chain 204 may include a plurality of track shoes 208, each configured to selectively engage a surface, e.g., the ground surface 108. Each track chain 204 may include a plurality of link subassemblies 210. Bottom support rollers 212 are also provided at the bottom of the undercarriage 200 to support the track chain 204 and a top support roller 214 (may also be referred to as a carrier roller) is provided forward of the elevated drive sprocket 206 to provide support to the track chain 204 between the elevated drive sprocket 206 and the front idler wheel 202a.

The machine 100 includes an elevated drive sprocket 206 that is mounted on the undercarriage 200 of the machine 100, meaning that the drive sprocket 206 is disposed vertically above the front idler wheel 202a and the rear idler wheel 202b. It is to be understood that inline drive sprockets may be provided in other embodiments (e.g. rear idler wheel 202b may be replaced with a drive sprocket 206). The track chain 204 is routed about the front idler wheel 202a, and the rear idler wheel 202b and under the bottom support rollers 212 and over the top support roller 214.

The track chain 204 comprises sets of links 216, each set of links 216 being joined to each other by a track pin (not clearly shown) or bushing (not clearly shown) such that adjacent links are attached to each other in a rotatable or oscillating manner, allowing the links to articulate relative to each other as they move about the undercarriage. At least one of the links defines a link pitch distance 222 that is equal to the overall length of the track link 216.

A work implement such as a blade 104 may be attached to the front of the machine 100 while a ripper 106 may be attached to the rear of the machine 100. Either the ripper 106 or blade 104 may be omitted in other embodiments.

The machine 100 may also include a hydraulic cylinder/mechanism 224 for moving the front idler wheel 202a forwardly or rearward to adjust the tension in the track chain 204. A GPS antenna 110 and cab 112 for housing controls and an operator may also be provided depending on the machine 100 and its intended application. These features may be omitted in other embodiments.

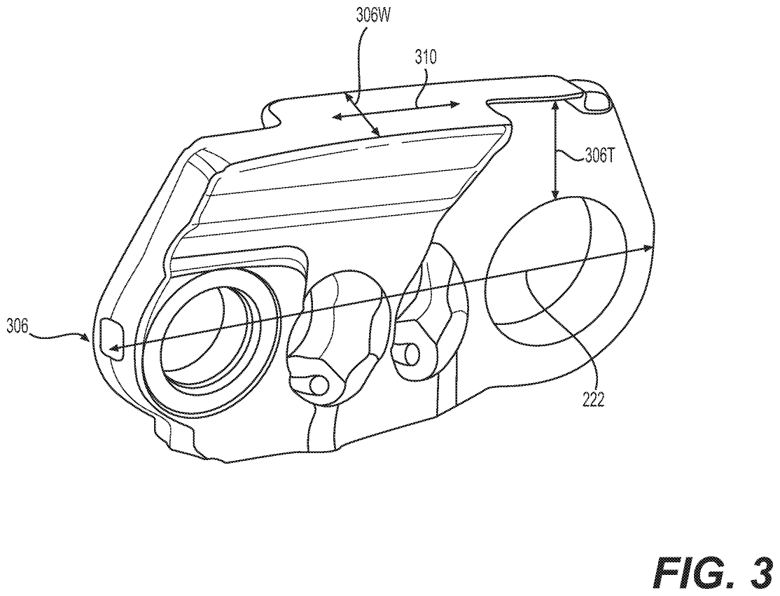

An undercarriage 300 according to an embodiment of the present disclosure may be described as follows looking at FIGS. 1 thru 3. The undercarriage 300 may further comprise a plurality of bottom support rollers 212 rotatably attached to the undercarriage 202 including a front bottom support roller 212a defining a front bottom support roller rotational axis 212aA and a rear bottom support roller 212b defining a rear bottom support roller rotational axis 212bA. The undercarriage may further comprise a front wheel 302 rotatably attached to the undercarriage 300, defining a front wheel rotational axis 302A and a rear wheel 304 rotatably attached to the undercarriage 300, defining a rear wheel rotational axis 304A. A track chain 204 may also be provided including sets of links 210, each set of links 210 being joined to each other in a rotatable manner. At least one of the links 306 defining a link pitch distance 222 equivalent to the overall length of the at least one link 306 (best seen in FIG. 3).

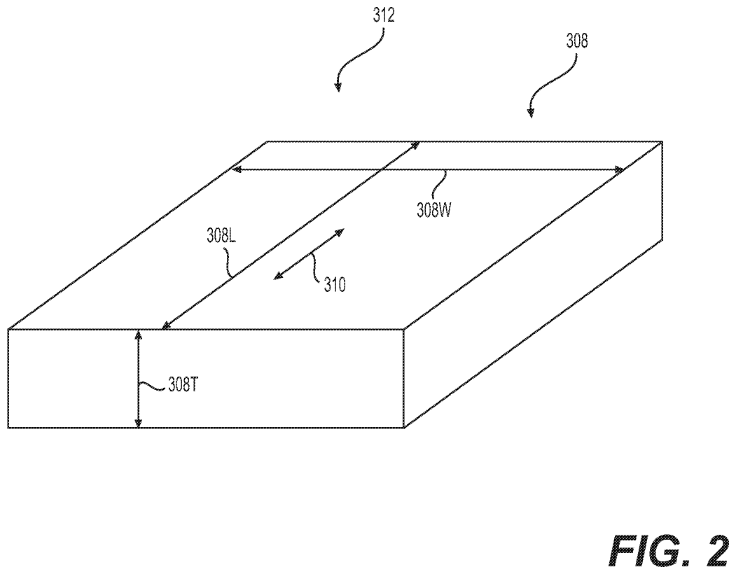

Looking at FIGS. 1 and 2, a first carrier plate 308 may be attached to the undercarriage 300 via fasteners, welding, etc. When a carrier plate is employed, a top support roller 214 may be omitted, but not necessarily so. The first carrier plate 308 may include a material having a hardness of at least 45 Rockwell Scale C or greater. In some embodiments, the first carrier plate 308 may comprise a material capable of being hardened such as a steel (e.g. AR400, AR450 etc.). In particular, AR400 steel may be used. In various embodiments, the first carrier plate 308 may be hardened to have a hardness value ranging from 45 Rockwell Scale C to 60 Rockwell Scale C, but not necessarily so.

Referring now to FIGS. 1 thru 3, the undercarriage 300 may define a track chain traveling direction 310. Also, the first carrier plate 308 may define a first carrier plate thickness 308T in a direction perpendicular to the track chain traveling direction 310, and at least one of the links 306 defines a rail thickness 306T in a direction perpendicular to the track chain traveling direction 310. A ratio of the rail thickness 306T to the carrier plate thickness 308T may range from 0.5 to 4.0. Likewise, the first carrier plate 302 may define a length 308L measured along the track traveling chain direction 310 and a ratio of the length 308L to the link pitch distance 222 ranges from 1.0 to 3.0. The first carrier plate 308 may further define a first carrier plate width 308W in a direction perpendicular to the track chain traveling direction 310, and at least one of the links 306 defines a rail width 306W in a direction perpendicular to the track chain traveling direction 310, and the ratio of the first carrier plate width 308W to the rail width 306W ranges from 2.0 to 6.0.

As alluded to earlier herein with reference to FIG. 1, the undercarriage 300 may further comprising an elevated drive sprocket 206 and the first carrier plate 308 may be disposed along the track chain traveling direction 310 between the elevated drive sprocket 206 and the front wheel 302. The undercarriage 300 may further comprise a second carrier plate 312 that is disposed along the track chain traveling direction 310 between the elevated drive sprocket 206 and the rear wheel 304. In some embodiments, the first carrier plate 308 and the second carrier plate 310 may be identically configured having the same hardness and material properties, etc. This may not be the case in other embodiments. A single carrier plate may be employed at any position in other embodiments.

All dimensions discussed herein are to be measured at the point of greatest extent for that dimension along the appropriate direction.

### INDUSTRIAL APPLICABILITY

In practice, a machine with an undercarriage configured to support a track chain, or an undercarriage configured to support a track chain according to any embodiment described herein may be sold, bought, manufactured or otherwise obtained in an OEM (Original Equipment Manufacturer) or after-market context. Carrier plates may also be provided as a replacement part or as a component used to retrofit existing machines or undercarriages already in the field.

Looking at FIG. 1, when one or more carrier plates are employed, track links with scalloped surfaces may have the these surfaces removed or otherwise compensated for by running past the carrier plate that is in contact with the track chain. This may extend the useful of the track chain in certain applications.

The dimensions and ratios discussed herein may help to ensure that the useful life of the carrier plate and/or track link is maximized or that the functionality of the carrier plate and/or track link is maximized. The ratios may represent an appropriate trade off or compromise between various competing performances. For example, the ratio of the thicknesses of the carrier plate and the rail of the track link may help to balance the useful life of the track chain while maintaining rider comfort, etc.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, it is intended that the specification and examples be considered as exemplary only, with a true scope and spirit of the invention(s) being indicated by the following claims and their equivalents.

What is claimed is:

1. An undercarriage configured to support a track chain and to be attached to a machine with an endless track drive, the undercarriage comprising:
a plurality of bottom support rollers rotatably attached to the undercarriage including a front bottom support roller defining a front bottom support roller rotational axis and a rear bottom support roller defining a rear bottom support roller rotational axis,
a front wheel rotatably attached to the undercarriage, defining a front wheel rotational axis;
a rear wheel rotatably attached to the undercarriage, defining a rear wheel rotational axis;
a track chain including sets of links, each set of links being joined to each other in a rotatable manner, at least one of the links defining a link pitch distance equivalent to the overall length of the at least one link; and
a first carrier plate attached to the undercarriage, the first carrier plate including a material having a hardness of at least 45 Rockwell Scale C or greater.

2. The undercarriage of claim 1 wherein the hardness ranges from 45 Rockwell Scale C to 60 Rockwell Scale C.

3. The undercarriage of claim 2 wherein the undercarriage defines a track chain traveling direction, the first carrier plate defines a first carrier plate thickness in a direction perpendicular to the track chain traveling direction, and at least one of the links defines a rail thickness in a direction perpendicular to the track chain traveling direction, and the ratio of the rail thickness to the carrier plate thickness ranges from 0.5 to 4.0.

4. The undercarriage of claim 3 wherein the first carrier plate defines a length measured along the track traveling chain direction and a ratio of the length to the link pitch distance ranges from 1.0 to 3.0.

5. The undercarriage of claim 1 wherein the first carrier plate comprises AR400 steel.

6. The undercarriage of claim 3 further comprising an elevated drive sprocket and the first carrier plate is disposed along the track chain traveling direction between the elevated drive sprocket and the front wheel.

7. The undercarriage of claim 6 further comprising a second carrier plate that is disposed along the track chain traveling direction between the elevated drive sprocket and the rear wheel.

8. An undercarriage configured to support a track chain and to be attached to a machine with an endless track drive, the undercarriage comprising:
a plurality of bottom support rollers rotatably attached to the undercarriage including a front bottom support roller defining a front bottom support roller rotational axis and a rear bottom support roller defining a rear bottom support roller rotational axis;
a front wheel rotatably attached to the undercarriage, defining a front wheel rotational axis;
a rear wheel rotatably attached to the undercarriage, defining a rear wheel rotational axis;
a track chain including sets of links, each set of links being joined to each in a rotatable manner, at least one of the links defining a link pitch distance equivalent to the overall length of the at least one link; and
wherein the undercarriage defines a track chain traveling direction, the first carrier plate defines a first carrier plate thickness in a direction perpendicular to the track chain traveling direction, and at least one of the links defines a rail thickness in a direction perpendicular to the track chain traveling direction, and the ratio of the rail thickness to the first carrier plate thickness ranges from 0.5 to 4.0.

9. The undercarriage of claim 8 wherein the first carrier plate has a hardness ranging from 45 Rockwell Scale C to 60 Rockwell Scale C.

10. The undercarriage of claim 9 further comprising a second carrier plate having a hardness ranging from 45 Rockwell Scale C to 60 Rockwell Scale C.

11. The undercarriage of claim 8 wherein the first carrier plate defines a length measured along the track traveling chain direction, and a ratio of the length to the pitch link distance ranges from 1.0 to 3.0.

12. The undercarriage of claim 8 wherein the first carrier plate comprises AR400 steel.

13. The undercarriage of claim 10 further comprising an elevated drive sprocket and the first carrier plate is disposed along the track chain traveling direction between the elevated drive sprocket and the front wheel.

14. The undercarriage of claim 10 wherein the first carrier plate and the second carrier plate are identically configured.

15. An undercarriage configured to support a track chain and to be attached to a machine with an endless track drive, the undercarriage comprising:
a plurality of bottom support rollers rotatably attached to the undercarriage including a front bottom support roller defining a front bottom support roller rotational axis and a rear bottom support roller defining a rear bottom support roller rotational axis;
a front wheel rotatably attached to the undercarriage, defining a front wheel rotational axis;
a rear wheel rotatably attached to the undercarriage, defining a rear wheel rotational axis;
a track chain including sets of links, each set of links being joined to each other in a rotatable manner, at least one of the links defining a link pitch distance equivalent to the overall length of the at least one link; and
wherein the undercarriage defines a track chain traveling direction, the first carrier plate defines a first carrier plate width in a direction perpendicular to the track chain traveling direction, and at least one of the links defines a rail width in a direction perpendicular to the track chain traveling direction, and the ratio of the first carrier plate width to the rail width ranges from 2.0 to 6.0.

16. The undercarriage of claim 15 wherein the first carrier plate has a hardness ranging from 45 Rockwell Scale C to 60 Rockwell Scale C.

17. The undercarriage of claim 16 further comprising a second carrier plate having a hardness ranging from 45 Rockwell Scale C to 60 Rockwell Scale C.

18. The undercarriage of claim 15 wherein the first carrier plate defines a length measured along the track traveling chain direction and a ratio of the length to the pitch link distance ranges from 1.0 to 3.0.

19. The undercarriage of claim 15 wherein the first carrier plate comprises AR400 steel.

20. The undercarriage of claim 15 further comprising an elevated drive sprocket and the first carrier plate is disposed along the track chain traveling direction between the elevated drive sprocket and the front wheel.
